(19) United States
(12) Patent Application Publication
(10) Pub. No.: US 2024/0376355 A1
(43) Pub. Date: Nov. 14, 2024

(54) POLYURETHANE BASED HOT MELT ADHESIVE

(71) Applicant: SABIC GLOBAL TECHNOLOGIES B.V., BERGEN OP ZOOM (NL)

(72) Inventors: Lidia Jasinska-Walc, Veldhoven (NL); Robbert Duchateau, Roostenlaan (NL); Miloud Bouyahyi, Eindhoven (NL); Jakub Kruszynski, Geleen (NL)

(21) Appl. No.: 18/290,053

(22) PCT Filed: May 11, 2022
(86) PCT No.: PCT/EP2022/062861

§ 371 Date: Nov. 9, 2023

(30) Foreign Application Priority Data
May 11, 2021 (EP) 21173371.2

(51) Int. Cl. C09J 175/04; C08G 18/62; C08G 18/76

(52) U.S. Cl. CPC C09J 175/04; C08G 18/6204; C08G 18/7671; C08G 2170/20

(57) ABSTRACT

Hot melt adhesive including a randomly hydroxyl functionalized branched olefin copolymer has: number average molecular weight between 10 to 50 kg/mol, crystallinity content below 30%, enthalpy between 5 to 65 J/g, polydispersity index from 2 to 6, melting temperature between 40 and 120° C., optionally, more than two hydroxyl functionalities per polymer chain and consisting of at least 80 mol % of a unit of formula (1), optionally a unit of formula (2), and between 0.1 to 1 mol %, of a unit of formula (3):

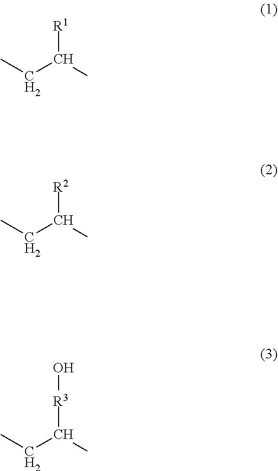

wherein:
R¹ is H or CH₃; R² is a C₀₋₁₀ hydrocarbyl group; R³ is a C₂₋₁₀ hydrocarbyl group, and the hydroxyl functionalized olefin copolymer has undergone an addition reaction with a di-, tri-or polyisocyanates of formula (4):

O═C═N—R⁴ [symbol] N═C═O)ₙ
Wherein, R⁴ is a C₁₋₁₀ hydrocarbyl group.

### CROSS REFERENCE TO RELATED APPLICATIONS

This application is a National Stage application of PCT/EP2022/062861, filed May 11, 2022, which claims the benefit of European Application No. 21173371.2, filed May 11, 2021, both of which are incorporated by reference in their entirety herein.

### TECHNICAL FIELD OF THE INVENTION

The present invention relates to polyurethane based hot melt adhesive.

### TECHNOLOGICAL BACKGROUND OF THE INVENTION

Hot Melt Adhesive (HMA) also known as hot glue is a thermoplastic adhesive resin that is solid at ambient temperature and can be molten to apply it on a surface. Most commonly EVA or polyolefin elastomers are applied as HMA. Other examples are thermoplastic polyurethanes (TPU), styrene block copolymers (SBC), polyamides or polyesters.

The HMA can be applied in several forms such as sticks, pellets, beads, granulates, pastilles, chips, slugs, flyers, pillows, blocks, films or spray and in various applications like packaging, hygiene products, furniture, footwear, textile & leather, electronics, book binding and graphics, building & construction, consumer DIY.

HMA provides several advantages over solvent-based adhesives. Volatile organic compounds are reduced or eliminated and drying or curing steps, typically required for 2 component adhesives, is eliminated. Furthermore, HMA typically have high mileage, low odor and are thermally stable. HMA have long shelf life and usually can be disposed of without special precautions. Furthermore, being a thermoplast, a HMA bond can be simply reversed by heating the substrate. The obvious drawback of this reversible bonding is the loss of bond strength at higher temperatures, up to complete melting of the adhesive. Hence, the use of HMA is limited to applications not exposed to elevated temperatures.

Polyolefin-based HMA's show good adhesion to low surface-energy materials such as untreated polyolefins or they can be applied to porous materials such as paper, carton or wood where the adhesion is obtained by physical inclusion of the HMA in the porous material. However, these polyolefin-based HMA's typically show low adhesive strength to polar materials such as metals, glass and polar polymeric materials.

EP1186619, disclose the use of polar functionalized monomer having more than 13 carbons C₁₃ in a polyolefin based HMA to improve the adhesion to polar substrates such as polycarbonates and aluminum.

However, HMA containing such functionalized monomer have a limited adhesive strengths.

Polyurethanes are outstanding polymers as they exhibit a high performance and versatility, which allows them to be employed in a vast range of industrial and engineering applications including adhesives. Polyurethanes are typically produced through the reaction of di-, tri- or polyisocyanates with the hydroxyl groups of a chain extender, typically a low molecular weight polyether, polyester or polybutadiene. It is known that the durability of isocyanate adhesives strongly depends on the presence of water as water accelerates the degradation of the joint.

It is an object of the present invention to provide a hot melt adhesive comprising a polar group-containing olefin copolymer having excellent adhesion properties to metals or polar and nonpolar resins.

There is a need for a new hot melt adhesive having at least one of the following binding properties, measured according to the ASTM D1002-10(2019) with a Zwick type Z020 tensile tester equipped with a 10 kN load cell:
Steel to steel with a Lap Shear Strength above 3 MPa, preferably above 4 MPa, more preferably above 5 MPa, even more preferably above 9 MPa,
Aluminum to aluminum with a Lap Shear Strength above 3 MPa, preferably above 4 MPa, more preferably above 5 MPa,
Polyolefin to polyolefin with a Lap Shear Strength above 3 MPa, preferably above 4 MPa, more preferably above 5 MPa,

### SUMMARY

This object is achieved by the present invention, an hot melt adhesive comprising a randomly hydroxyl functionalized branched olefin copolymer having:
Number average molecular weight (Mn) between 10 to 50 kg/mol, preferably between 20 to 50 kg/mol, measured according to the ISO 16014-4 and ASTM D6474 methods at 150° C. on a Polymer Char GPC-IR® built around an Agilent GC oven model 7890
Enthalpy (AH) between 5 to 65 J/g, preferably 5 to 30J/g, measured according to ISO 11357-1:2016 using a Differential Scanning Calorimeter Q100 from TA Instruments,
Polydispersity index (PDI) from 2 to 6, preferably strictly superior to 3 and inferior to 6, measured according to the method ISO 16014-4 and ASTM D6474 methods at 150° C. on a Polymer Char GPC-IR® built around an Agilent GC oven model 7890,
Melting temperature (Tm) between 40 and 120° C., measured according to ISO 11357-1:2016 using a Differential Scanning Calorimeter Q100 from TA Instruments,
At least two or more hydroxyl functionalities per polymer chain which has been characterized by 1H NMR, and
   wherein the randomly hydroxyl functionalized branched olefin copolymer is at least partly crystalline and having a crystallinity (Xc) level below 40%, preferably below 30%, more preferably 15%, even more preferably below 10%, and preferentially above 1%, more preferably above 5%, measured according to ISO 11357-1:2016 using a Differential Scanning Calorimeter Q100 from TA Instruments, and
   wherein the randomly hydroxyl functionalized branched olefin copolymer is consisting of: at least 80 mol % of a constituent unit represented by the following formula (1), optionally a constituent unit represented by the following formula (2), and between 0.1 to 1 mol %, preferably 0.1 to 0.5 mol %, of a constituent unit represented by the following formula (3):

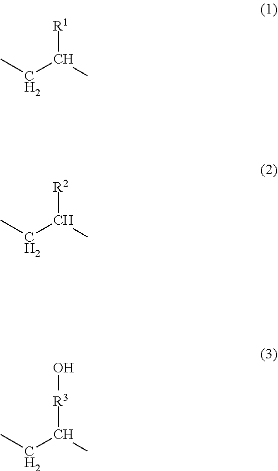

### Wherein:

R¹ is H or CH₃.
R² is selected from the list comprising: hydrocarbyl group having 0 to 10 carbon atoms, preferentially 2 to 6 and more preferentially 6 when R¹═H, and preferably 0, 2 or 4 when R¹═CH₃.
R³ is a hydrocarbyl group having 2 to 10 carbon atoms, preferentially 2 to 8, preferentially 4 to 8, more preferentially 4 or 6,
   and wherein the hydroxyl functionalized olefin copolymer has been undergone an addition reaction with a di-, tri-or poly-isocyanates represented by the following formula (4):

O═C═N—R⁴ [symbol] N═C═O)ₙ

wherein:
R⁴ is hydrocarbyl group having 1 to 10 carbon atoms
n is 1 to 4, preferentially 1 to 2, more preferentially 1.

As the randomly hydroxyl functionalized branched olefin copolymer has a Tm and a ΔH is 5 or larger, that means that the randomly hydroxyl functionalized branched olefin copolymer is not amorphous and at least partly crystalline.

In some embodiment, the constituent unit represented by the following formula (3) is selected from the group comprising 3-buten-1-ol, 3-buten-2-ol, 5-hexen-1-ol, 5-hexene-1,2-diol, 7-octen-1-ol, 7-octen-1,2-diol, 5-norbornene-2-methanol, 10-undecen-1-ol, preferably 5-hexen-1-ol.

In some embodiment, the polymerization has been performed using a solution process.

In some preferred embodiment, the copolymerization is performed using an olefin polymerization catalyst system that provides semi-crystalline randomly hydroxyl functionalized branched olefin copolymers with a crystallinity in the range of 5% to 40%, preferably 10%-30%, more preferably 10%-25%.

In some embodiment, a purification step, referred to as deashing, consisting of removing traces of the inorganic impurities, which remain in the resin after polymerization, has been performed.

Another aspect of the invention is the use of polyurethane based hot melt adhesive according to the invention, in order to glue together metals, glass, polar polymers or metals to glass, metal to polar polymers, glass to polar polymers, metals to polyolefins, glass to polyolefins, polar polymers to polyolefins or polyolefins to polyolefins.

### BRIEF DESCRIPTION TO THE DRAWINGS

FIG. 1 is the 1H NMR spectrum of EX1,

FIG. 2 is the 1H NMR spectrum of EX2,

FIG. 3 is the 1H NMR spectrum of EX3, and

FIG. 4 is the 1H NMR spectrum of EX4.

### DETAILED DESCRIPTION

The present invention preferably relates to a polyolefin-based hot melt adhesive resin comprising hydroxyl functionalities that are reacted with di-tri-or poly-isocyanates to form a cross-linked system.

Besides the known high adhesive strength of polyurethane adhesives, the polyolefin-based polyurethane hot melt adhesives of the invention are expected to provide excellent durability due to the high water barrier of the polyolefins. Using relatively high molecular weight randomly branched hydroxyl-functionalized olefin copolymer resins, the corresponding polyurethane hot melt adhesive will not only show good adhesion to polar substrates such as metals, glass and polar polymers, but also to low surface energy materials such as polyolefins.

To ensure a well-crosslinked system that will guarantee strong bonding to various substrates, it is preferably that the randomly hydroxyl functionalized branched olefin copolymer contain more than two hydroxyl functionalities per polymer chain. In a preferred embodiment, the randomly hydroxyl functionalized branched olefin copolymer contains at least two or more hydroxyl functionalities per polymer chain.

According to the invention, the polyolefin-based hot melt adhesive resin comprises a copolymer of at least one first olefin monomer and a hydroxyl functionalized C₂ to C₁₂, preferably C₄ to C₁₂, more preferably C₄ to C₁₀ olefin monomer, which has been undergone an addition reaction with a di-, tri-or poly-isocyanates resulting in to a cross-linked system according to formula (5):

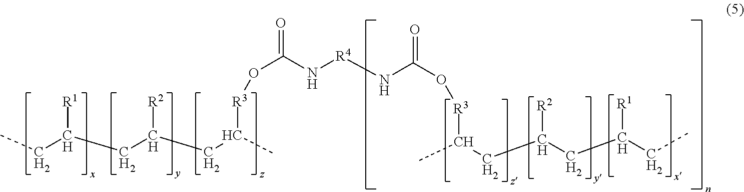

wherein
z, z′ is 0.1 to 1 mol %,
x, x′ is at least 80 mol %,
y is 0 or 100−(x+z) mol %, and y′ is 0 or 100−(x′+z′) mol %,
R1 is H or CH3,
R2 is selected from the list comprising: hydrocarbyl group having 0 to 10 carbon atoms, preferentially 2 to 6 and more preferentially 6 when R¹═H, and preferably 0, 2 or 4 when R¹═CH₃,
R³ is a hydrocarbyl group having 2 to 10 carbon atoms, preferentially 2 to 8, preferentially 4 to 8, more preferentially 4 or 6,
R⁴ is hydrocalbyl group having 1 to 10 carbon atoms,
n is 1 to 4, preferentially 1 to 2, more preferentially 1.

In some embodiment, due to the nature of the environmental reaction, not all the hydroxyl group present in the copolymer have reacted with an isocyanate functionality, preferably at least 40% of the OH groups have been reacted, preferably more than 50%.

As not all the hydroxyl group present in the copolymer react, in some embodiment, it is preferred to have more than 2 hydroxyl functionalities per polymer chain to ensure efficient cross-linking.

In some embodiment, the first olefin monomer is ethylene or propylene, preferably propylene.

In some embodiment, the hot melt adhesive resin according to the invention is a polyolefin-based copolymer, preferably a terpolymer resulting from the polymerization of a first olefin monomer, with optionally a second olefin monomer selected from the list comprising ethylene or C₃ to C₁₂ olefin monomer and a third—functionalized—olefin monomer, which is selected from the list comprising a hydroxyl functionalized C₂ to C₁₂, preferably C₄ to C₁₂ olefin monomer.

In a preferred embodiment, the second olefin monomer is “non-functionalized, non-activated olefin monomer”, meaning an olefin monomer only consisting of carbon and hydrogen atoms.

In some embodiment, when the first olefin monomer is ethylene, preferably the second olefin monomer is 1-butene, 1-hexene or 1-octene.

In some embodiment, when the first olefin monomer is propylene, preferably the second olefin monomer is ethylene, 1-butene, 1-hexene or 1-octene.

In some embodiment, the third monomer is a hydroxyl functionalized olefin monomer, preferably 3-buten-1-ol, 3-buten-2-ol, 5-hexen-1-ol, 5-hexene-1,2-diol, 7-octen-1-ol, 7-octen-1,2-diol, 5-norbornene-2-methanol, 10-undecen-1-ol, preferably 5-hexen-1-ol.

In some embodiment, the hot melt adhesive resin is made in a solution process using a protected hydroxyl-functionalized C₄ to C₁₂, preferably C₆ to C₁₂, preferably C₆ to C₁₀, preferably C₆ to C₈ olefin monomer. Generally, the protection group is silyl halides, trialkyl aluminum complexes, dialkyl aluminum alkoxide complexes, dialkyl magnesium complexes, dialkyl zinc complexes or trialkyl boron complexes.

Although this is not essential, a purification step consisting in removing the traces of inorganic impurities such as aluminum hydroxide oxide species, which remained in the polymer the resin after the polymerization process, is preferred.

By doing so, the best adhesion strengths are obtained. Inventors believe that by removing the inorganic impurities from the resin, it allows to have more hydroxyl functionalities available to enhance the binding property of the resin to polar materials.

According to the invention, the addition reaction of the hydroxyl-functionalized polyolefin is performed with a di-, tri-or poly-isocyanates with an isocyanates according to formula (4)

O═C═N—R⁴ [symbol] N═C═O)ₙ (4)

wherein:
R⁴ is hydrocarbyl group having 1 to 10 carbon atoms
n is 1 to 4, preferentially 1 to 2, more preferentially 1.

In some embodiment, the isocyanate is selected from the list comprising 1,6-Diisocyanatohexane (HDI), 4,4′-methylene diphenyl diisocyanate (MDI), Methylene-bis (4-cyclohexylisocyanate) (HMDI).

### EXAMPLES

The following formula (6) represent an non limitative example of the invention in which the used isocyanate is a di-isocyanate

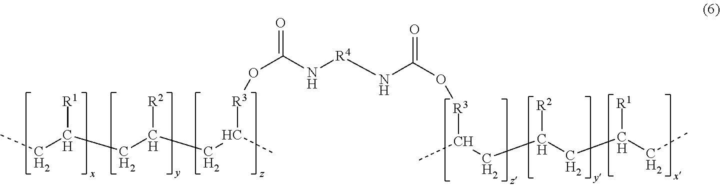

The tunable functionality of these functionalized olefin terpolymer HMA's makes them very suitable for gluing the same or different polar substrates such as metals, glass, wood and polar polymers.

The general apolar nature of the functionalized olefin terpolymer HMA's furthermore provides excellent adhesion to low surface energy substrates such as polyolefins (i.e. HDPE, LDPE, LLDPE, PP), making these HMA's very suitable for gluing polyolefins to polyolefins, or for gluing polyolefins to polar substrates such as metals, glass, wood and polar polymers.

The following examples are not limiting examples and have been realized with the following monomers: propylene (C₃), 1-hexene (C₆), and 5-hexen-1-ol (C₆OH). However, other monomer could be use in order to achieve the present invention.

### Synthesis of Poly (C₃co-C₅-co-C₆OH)

The polymerization experiment was carried out using a stainless steel BÜCHI reactor (2 L) filled with pentamethylheptane (PMH) solvent (1 L) using a stirring speed of 600 rpm. Catalyst and comonomer solutions were prepared in a glove box under an inert dry nitrogen atmosphere.

The reactor was first heated to 40° C. followed by the addition of TiBA (1.0 M solution in toluene, 2 mL), 1-hexene (neat 10 mL), and triethylaluminum (TEA)-pacified 5-hexen-1-ol (1.0 M solution in toluene, TEA:5-hexen-1-ol (mol ratio)=1, 10 mL). The reactor was charged at 40° C. with gaseous propylene (100 g) and the reactor was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl) phenyl)-2-phenoxy)-2,4-pentanediylhafnium (IV) dimethyl [CAS 958665-18-4]; other name hafnium [[2′,2′″-[(1,3-dimethyl-1,3-propanediyl)bis(oxy-κO)]bis[3-(9H-carbazol-9-yl)-5-methyl[1,1′-biphenyl]-2-olato-κO]](2-)]dimethyl] (Hf-O4, 2 μmol) in MAO (30 wt % solution in toluene, 11.2 mmol). The reaction was stopped by pouring the polymer solution into a container flask containing demineralized water/iPrOH (50 wt %, 1 L) and Irganox 1010 (1.0 M, 2 mmol). The resulting suspension was filtered and dried at 80° C. in a vacuum oven, prior the addition of Irganox 1010 as an antioxidant. The poly (propylene-co-1-hexene-co-5-hexen-1-ol) (25.6 g) was obtained as a white powder.

### Deashing Protocol

The terpolymer obtain from the solution process may be purify in order to remove trace of inorganic impurities, such as aluminum hydroxide oxides. To do so, the poly (C₃-co-C₆-CO-C₆OH) (10 g) (Table 1, entry 1) was dispersed in mixture of dry toluene (400 ml) and concentrated (37%) HCl (10 ml, 0.13 mol, 4.74 g) and heated under reflux until the terpolymer dissolved. Once the polymer was properly dissolved, methanol (250 ml) was added to the hot mixture and the mixture was heated under stirring at 90-100° C. for 1 additional hour. Then the polymer was precipitated in cold methanol, filtered and washed 2× with methanol. The yield of purification process was 85%.

### Polyurethane Synthesize Protocol

EX2: poly (C₃-co-C₆-co-C₆O-(MDI).

Deashed and degassed poly (C₃-co-C₆-co-C₆OH) (0.4 mol % OH; Mn=26.6 kg-mol−1; PDI=4.6; 5.6·10−4 mol, 15 g; Table 1, entry 1) was dissolved in 400 ml of dry toluene at 110° C. The process was carried out under reflux and nitrogen atmosphere. When homogenous mixture was obtained, freshly distilled 4,4′-methylene diphenyl diisocyanate (1.5·10−3 mol, 0.375 g) (MDI) was introduced to the thus obtained polymer solution. After 10 min, dibutyltin dilaurate as a catalyst was added (7.9·10−4 mol; 0.498 g). The reaction was carried out for 22 h under nitrogen atmosphere at 110° C. The product was recovered by precipitation in cold methanol and dried under reduced pressure at 60° C. The yield of the reaction was 87%. The final product obtained after drying was partially cross-linked and therefore difficult to dissolve in common organic solvents e.g. 1,2-dichlorobenzene

EX3: poly (C₃-co-C₆-co-C₆-O-(HDI) and EX4 poly(C₃-co-C₆-co-C₆O-(HMDI)

EX3 and EX4 were synthesized under analogue conditions and protocol that the ones used for EX2 at the exception that 4,4′-methylene diphenyl diisocyanate (MDI) has been replace respectively by 1,6-Diisocyanatohexane (HDI) and Methylene-bis (4-cyclohexylisocyanate) (HMDI).

TABLE 1
Characteristics of copolymer and terpolymers with different composition
produced according to the abovementioned protocols.

| | | | | OH | | | | |
|---|---|---|---|---|---|---|---|---|
| | | C₃:C₂₋₆₋₈: | Xc | group | Mₙ | PDI | Tₘ | ΔHₘ |
| EX | Composition | C₆OH* | [%] | mol % | [kg/mol] | (M_{w}/Mₙ) | [° C.] | [J/g] |
| EX1 | poly(C₃-co-C₆-co-C₆OH) | 96.3:3.4:0.3 | 13.5 | 0.4 | 26.6 | 4.6 | 88.2 | 27.9 |
| EX 2 | poly(C₃-co-C₆-co-C₆O-(MDI) | 96.3:3.4:0.3 | 12.5 | — | —* | —* | 87.5 | 25.8 |
| EX 3 | poly(C₃-co-C₆-co-C₆O-HDI) | 96.3:3.4:0.3 | 10.9 | — | —* | —* | 87.4 | 22.5 |
| EX 4 | poly(C₃-co-C₆-co-C₆O-(HMDI) | 96.3:3.4:0.3 | 13.9 | — | —* | —* | 86.0 | 22.5 |

*not soluble in 1,2-dichlorobenzine

TABLE 2
Lap shear test results.

| | Lap Shear Strength [MPa] | | |
|---|---|---|---|
| EX | ALUMINUM/ALUMINUM | STEEL/STEEL | PP/PP |
| EX1 | 7.66 ± 0.13 | 13.5 ± 1.12 | 6.5 ± 0.3 |
| EX2 | 5.95 ± 0.65 | 9.47 ± 0.86 | 5.5 ± 0.3 |
| EX3 | 5.90 ± 0.59 | 4.88 ± 1.64 | 5.3 ± 0.3 |
| EX4 | 4.70 ± 0.33 | 5.51 ± 0.54 | 4.5 ± 0.3 |

TABLE 3
Dynamic Mechanical Thermal Analysis

| | | Storage modulus (E′) [MPa] | | | | Loss modulus (E″)[MPa] | | | |
|---|---|---|---|---|---|---|---|---|---|
| Entry | Tg ° C. | −40° C. | 0° C. | 20° C. | 70° C. | −40° C. | 0° C. | 20° C. | 70° C. |
| EX1 | −1.33 | 2015 | 381 | 112 | 5.6 | 35.8 | 115.7 | 14.5 | 0.5 |
| EX2 | 1.66 | 2221 | 534 | 120 | 13 | 40.5 | 171.3 | 17.2 | 1.0 |
| EX3 | 0.01 | 2814 | 569 | 148 | 11.7 | 46 | 188.7 | 18.5 | 0.9 |
| EX4 | 3.29 | 2045 | 643 | 132 | 7.2 | 36.2 | 187.5 | 21.5 | 0.6 |

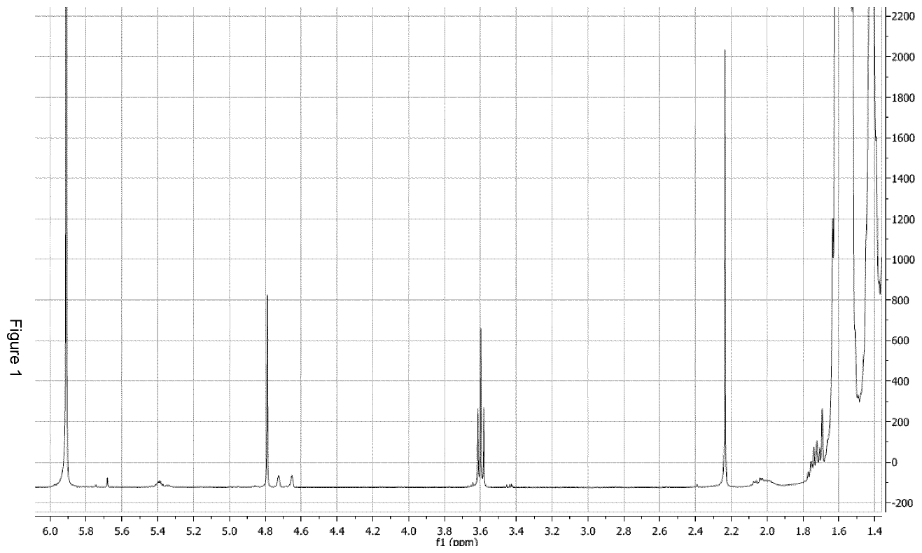

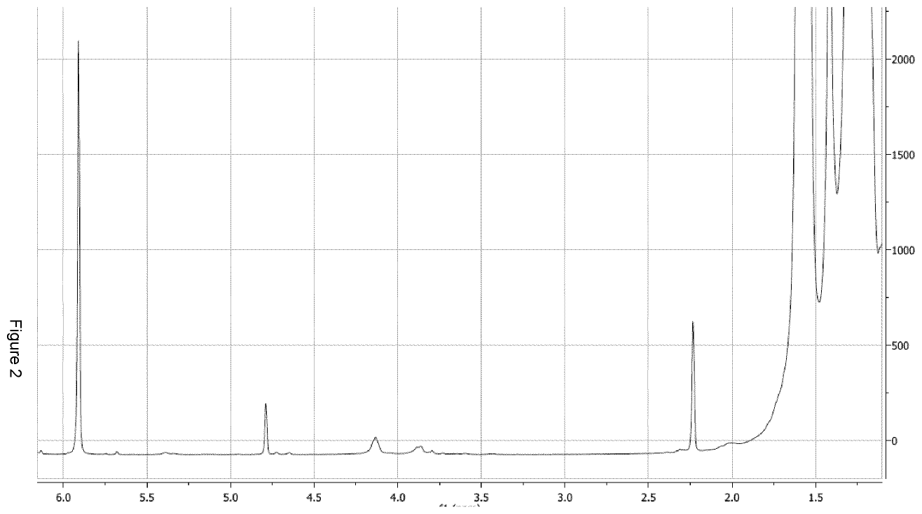

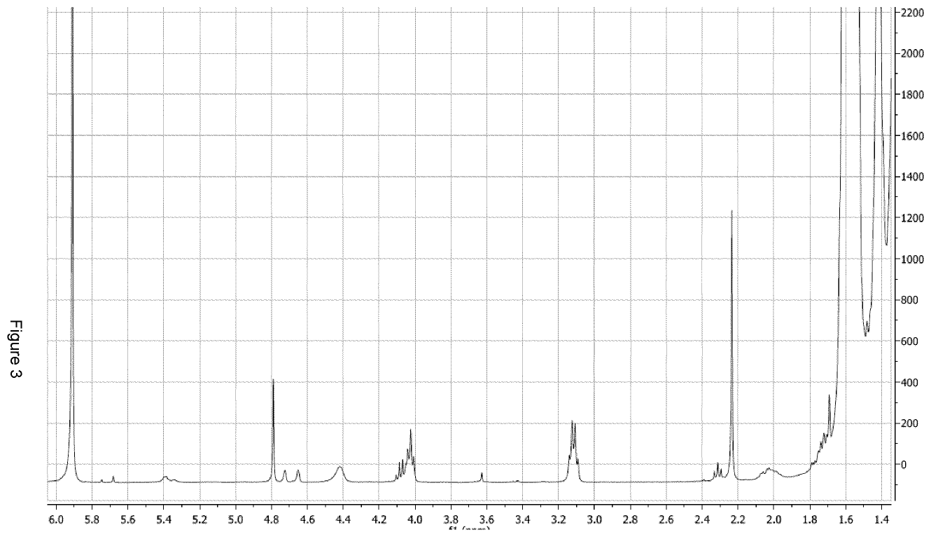

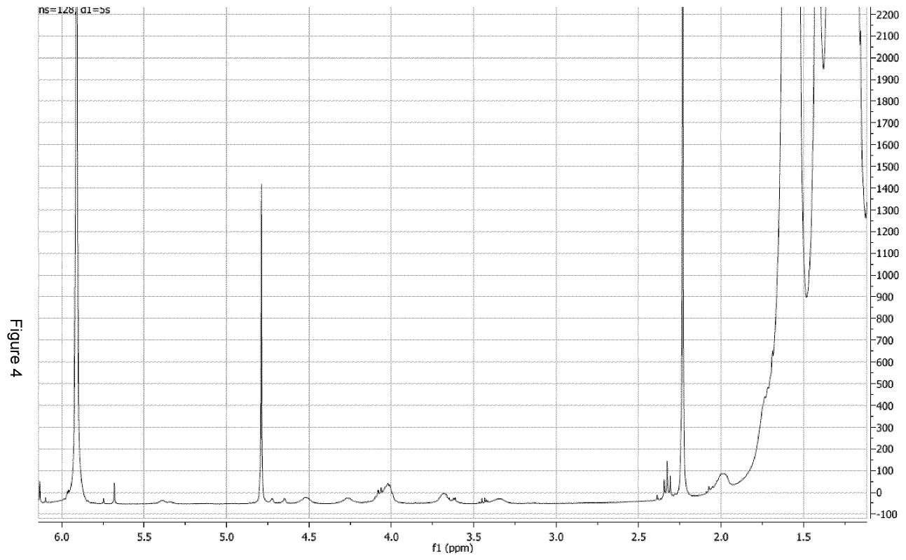

FIGS. 1, 2, 3 and 4 are the 1H NMR spectra of respectively EX1, EX2, EX3 and EX4 in which it can be observe the functionality level and the comonomer composition.

### Measurements

### Size Exclusion Chromatography (SEC)

SEC measurements were performed according to ISO 16014-4 and ASTM D6474 methods at 150° C. on a Polymer Char GPC-IR® built around an Agilent GC oven model 7890, equipped with an autosampler and the Integrated Detector IR4. 1,2-Dichlorobenzene (o-DCB) was used as an eluent at a flow rate of 1 mL/min. The data were processed using Calculations Software GPC One®. The molecular weights (Mn) (Mw) and PDI were calculated with respect to polyethylene or polystyrene standards.

### Liquid-State 1H NMR

¹H NMR and 13C NMR spectra were recorded at room temperature or at 80° C. using a Varian Mercury Vx spectrometer operating at Larmor frequencies of 400 MHz and 100.62 MHZ for ¹H and ¹³C, respectively. For ¹H NMR experiments, the spectral width was 6402.0 Hz, acquisition time 1.998 s and the number of recorded scans equal to 64. ¹³C NMR spectra were recorded with a spectral width of 24154.6 Hz, an acquisition time of 1.3 s, and 256 scans.

### Differential Scanning Calorimetry (DSC)

Melting (Tₘ) temperatures as well as enthalpies of the melting point (ΔH [J/g]) of the transitions were measured according to the ISO 11357-1:2016 using a Differential Scanning Calorimeter Q100 from TA Instruments. The measurements were carried out at a heating and cooling rate of 10° C./min from-50° C. to 240° C. The transitions were deducted from the second heating and cooling curves.

The DSC has been used for the determination of the Crystallinity (X_{c}) content by comparing the enthalpies of melting transition of the sample with melting transition of the 100% crystalline polypropylene.

### Dynamic Mechanical Thermal Analysis (DMTA)

Storage modulus (E′) and Loss modulus (E″)[MPa] were measured using a TA Instruments Q800 DMA. Samples were tested by strain-controlled temperature ramp with the frequency of 1 Hz. The temperature profile was from −150° C. to the melting of the polymers with the ramp 3° C./min. The glass transition temperature was calculated as the peak of the tangent delta signal.

### Compression-Molding Experiments

The film samples, used for the lap shear test, were prepared via compression-molding using PP ISO settings on LabEcon 600 high-temperature press (Fontijne Presses, the Netherlands). Namely, the films (25 mm×12.5 mm×0.5 mm) of functionalized polyolefins were loaded between the substrates: PP-PP, Steel-Steel, Aluminum-Aluminum or their combination with overlap surface 12.5 mm. Then, the compression-molding cycle was applied: heating to 130° C., stabilizing for 3 min with no force applied, 5 min with 100 kN (0.63 MPa) normal force and cooling down to 40° C. with 10° C./min and 100 kN (0.63 MPa) normal force.

### Lap Shear Strength

The measurements were performed according to the ASTM D1002-10 (2019) with a Zwick type Z020 tensile tester equipped with a 10 kN load cell. Before measurements, samples were conditioned for 7 days at room temperature. The tests were performed on specimens (10 cm×2.5 cm) with surface overlapping 12.5 mm. A grip-to-grip separation of 140 mm was used. The samples were pre-stressed to 3 N, then loaded with a constant cross-head speed 100 mm/min. To calculate the lap shear strength the reported force value divided by the bonding surface (25 mm×12.5 mm) of the specimens. The reported values are an average of at least 5 measurements of each composition.

1. A polyurethane based hot melt adhesive comprising a randomly hydroxyl functionalized branched olefin copolymer having:
a number average molecular weight (Mₙ) between 10 to 50 kg/mol, measured according to the ISO 16014-4 and ASTM D6474 methods at 150° C. on a Polymer Char GPC-IR® built around an Agilent GC oven model 7890
an enthalpy (ΔH) between 5 to 65 J/g, measured according to ISO 11357-1:2016 using a Differential Scanning Calorimeter Q100 from TA Instruments,
a polydispersity index (PDI) from 2 to 6, measured according to the method ISO 16014-4 and ASTM D6474 methods at 150° C. on a Polymer Char GPC-IR built around an Agilent GC oven model 7890,
a melting temperature (Tₘ) between 40 and 120° C., measured according to ISO 11357-1:2016 using a Differential Scanning Calorimeter Q100 from TA Instruments,
at least two or more hydroxyl functionalities per polymer chain, and
wherein the randomly hydroxyl functionalized branched olefin copolymer is at least partly crystalline and has a crystallinity (X_{c}) level below 40% and above 1%, measured according to ISO 11357-1:2016 using a Differential Scanning Calorimeter Q100 from TA Instruments, and
wherein the randomly hydroxyl functionalized branched olefin copolymer consists of:
at least 80 mol % of a constituent unit represented by the following formula (1),
optionally a constituent unit represented by the following formula (2), and
between 0.1 to 1 mol %, of a constituent unit represented by the following formula (3): 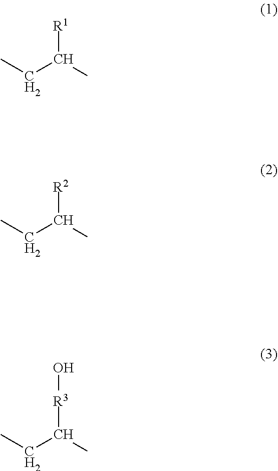
wherein:
R¹ is H or CH₃,
R² is a hydrocarbyl group having 0 to 10 carbon atoms,
R³ is a hydrocarbyl group having 2 to 10 carbon atoms,
and wherein the hydroxyl functionalized olefin copolymer has been undergone an addition reaction with a di-, tri-or poly-isocyanates represented by the following formula (4):
O═C═N—R⁴ [symbol] N═C═O)ₙ
wherein:
R⁴ is hydrocarbyl group having 1 to 10 carbon atoms, and.
n is 1 to 4.

2. The polyurethane based hot melt adhesive according to claim 1 wherein the constituent unit represented by the formula (3) is selected from the group consisting of 3-buten-1-ol, 3-buten-2-ol, 5-hexen-1-ol, 5-hexene-1,2-diol, 7-octen-1-ol, 7-octen-1,2-diol, 5-norbornene-2-methanol, and 10-undecen-1-ol.

3. The polyurethane based hot melt adhesive according to claim 1, wherein the polymerization has been performed using a solution process.

4. The polyurethane based hot melt adhesive according to claim 3, wherein a purification step consisting of removing traces of inorganic impurities, which remain in the resin after polymerization, has been performed prior the addition reaction.

5. The polyurethane-based hot melt adhesive according to claim 1, comprising the following cross-linked system 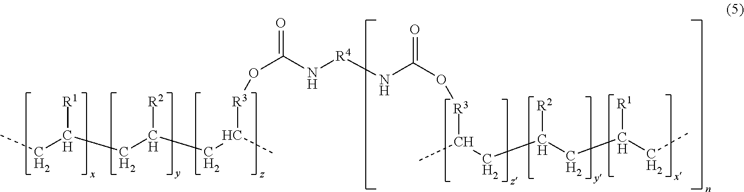
wherein
z, z′ is 0.1 to 1 mol %,
x, x′ is at least 80 mol %,
y is 0 or 100−(x+z) mol %, and y′ is 0 or 100−(x′+z′) mol %,
R¹ is H or CH₃,
R² is a hydrocarbyl group having 0 to 10 carbon atoms,
R³ is a hydrocarbyl group having 2 to 10 carbon atoms,
R⁴ is hydrocarbyl group having 1 to 10 carbon atoms, and
n is 1 to 4.

6. A method comprising: applying the polyurethane based hot melt adhesive according to claim 1 to glue together metals, glass, polar polymers or metals to glass, metal to polar polymers, glass to polar polymers, metals to polyolefins, glass to polyolefins or polar polymers to polyolefins.

7. The polyurethane based hot melt adhesive according to claim 1, having at least one of the following binding properties measured according to the ASTM D1002-10(2019) with a Zwick type Z020 tensile tester equipped with a 10 kN load cell:
steel to steel with a Lap Shear Strength above 3 MPa,
aluminum to aluminum with a Lap Shear Strength above 3 MPa, or
polyolefin to polyolefin with a Lap Shear Strength above 3 MPa.

8. The polyurethane based hot melt adhesive according to claim 1, having a storage modulus (E′) at 20° C. above 115 MPa, and at −40° C. above 2030 MPa, measured according to the method described in the section Dynamic Mechanical Thermal Analysis (DMTA) of the present application, and a Loss modulus (E″) at 20° C. above 17 MPa and at −40° C. above 36 MPa measured according to Dynamic Mechanical Thermal Analysis (DMTA).
